(19) United States
(12) Patent Application Publication
(10) Pub. No.: US 2024/0149541 A1
(43) Pub. Date: May 9, 2024

(54) Novel Liquid Matrix Impregnation Method and Apparatus for Composite Prepreg Production

(71) Applicant: THE UNIVERSITY OF SOUTH ALABAMA, MOBILE, AL (US)

(72) Inventors: KUANG-TING HSIAO, SPANISH FORT, AL (US); SEBASTIAN KIRMSE, ATLANTA, GA (US)

(21) Appl. No.: 18/549,501

(22) PCT Filed: Apr. 14, 2022
(86) PCT No.: PCT/US2022/024798

§ 371 Date: Sep. 7, 2023

Related U.S. Application Data
(60) Provisional application No. 63/175,254, filed on Apr. 15, 2021.

(51) Int. Cl. B29C 70/50; B29C 70/24; C08J 5/24

(52) U.S. Cl. CPC B29C 70/50; B29C 70/24; C08J 5/243

(57) ABSTRACT

A process for continuous production of z-threaded fiber reinforced polymer composites. The process includes providing a pre-formed fiber fabric including a plurality of fibers and a pre-formed, solidified film having a film thickness dimension, wherein the film includes a heat-meltable base matrix material in combination with a plurality of z-aligned nanofibers disposed within the base matrix material. The film and fiber fabric are advanced in layered relation through a constricting matrix transfer station, wherein the fiber fabric is heated to a temperature at or above the melting point of the base matrix material and the base matrix material progressively melts at an interface with the fabric face and flows with the nanofibers into the fiber fabric in the fabric thickness dimension as the film and fiber fabric move through the matrix transfer station. The matrix transfer station includes a constricting processing gap urging the film towards the fiber fabric through at least a portion of the matrix transfer station.

### CROSS REFERENCE TO RELATED APPLICATIONS

This nonprovisional application claims the benefit of, and priority from, U.S. provisional application 63/175,254 filed Apr. 15, 2021. The contents of such prior provisional application and all other documents referenced in this nonprovisional application are hereby incorporated by reference as if fully set forth herein in their entirety.

### GOVERNMENT RIGHTS

This invention was made with government support under a contract awarded by the National Science Foundation. The government has certain rights in the invention.

### TECHNICAL FIELD

The present disclosure relates generally to composite materials, and more particularly to methods and equipment for impregnation of matrix materials and resulting composite products.

### BACKGROUND

Traditional Fiber Reinforced Polymer (FRP) composites are made up of reinforcing fibers in the x-y plane and a polymer matrix to join the fibers together. As will be readily understood, in FRP composites, the reinforcing fibers may be formed into a mat or fabric structure in which the fibers are oriented in either crossing, parallel, or combined relation to one another to define a mat or fabric having a substantially planar structure. A polymer is then applied to fill the voids between the fibers to form the composite structure. Such traditional FRP composites are generally strong in the directions of the reinforcing fibers covered but may be weak in other directions not aligning with any of the fiber reinforcing directions. The reduced strength typically corresponds with the y and z directions of the mat or fabric structure and often corresponds with the through-thickness direction of the mat or fabric structure. However, the reduced strength may also correspond with other directions depending on the planar structure details.

Typical carbon FRPs (CFRPs) may be joined together into laminate structures which can be stronger and stiffer than steel, aluminum, and titanium with the same weight, when such strength is measured in the direction the carbon fibers are reinforcing. That is, a direction substantially parallel to the x-y plane defined by the reinforcing fibers. In this regard, it will be understood that the x-direction typically refers to the direction along the major fiber-reinforcing direction, which can be clearly distinguished in a unidirectional fabric, and the y-direction is the secondary planner direction perpendicular to the x-direction. However, typical CFRP laminates may have relatively low strength in the z-direction (i.e., the direction transverse to an x-y plane defined by the reinforcing fibers). In this regard, the z-direction often corresponds to the thickness dimension of the composite but may also correspond to any other dimension depending on the orientation of the reinforcing fibers making up the composite. This z-direction weakness in traditional CFRPs may exist within the polymer matrix between the reinforcing fibers and also at the matrix-fiber interface where the matrix material forms an adhesive bond to the fibers.

In traditional CFRPs, composite failure can be interlaminar failure (failed between two laminas (i.e., between two layers of fiber fabrics) or intralaminar failure (i.e., failure within a space between fibers within the same lamina). In addition to z-directional mechanical strength reduction, traditional CFRPs may also have issues with low thermal conductivity and low electrical conductivity in the z-direction since there is an absence of extended length fibers running in the z-direction and the polymer matrix is typically a good insulator for both heat and electricity.

To address shortcomings in traditional CFRPs, many researchers are adding nanoparticles such as carbon nanotubes or carbon nanofibers to the polymer matrix to improve the matrix's mechanical, electrical, and thermal properties. In this regard, “nanofibers” will be understood to include “nanotubes”, “nanofibers”, “nanorods”, “nano ropes” and the like. However, many of the results of such addition have shown no significant improvement and lack of consistency. The present inventors postulated that the alignment and how the nanofibers are placed inside the CFRP may have importance to the mechanical, thermal, and electrical reinforcing effects to be delivered by the nanofibers.

The present inventors have developed a z-threaded CFRP (i.e., ZT-CFRP) technology using carbon nanofibers oriented predominantly in the z-direction to address the z-direction related issues. Exemplary z-threaded CFRPs and methods of formation are described in co-owned U.S. Pat. No. 10,066,065B2, and International Application No.: PCT/US2015/033000, the teachings of all of which are incorporated by reference herein in their entirety as if fully set forth. As shown in FIGS. 1 and 2, in the z-threaded CFRP, the carbon nanofibers 10 extend longitudinally in threaded relation through a carbon fiber bed along the z-direction and form a 3D reinforcing fiber network with the structural carbon fibers 12, 14 making up the bed. By way of example only, and not limitation, the threaded nanofibers may have diameters of 0.001 to 1 micrometer and may preferably have a diameter of 0.05 to 0.15 micrometers with lengths of 10 to 1500 micrometers and preferably 100 to 500 micrometers. However, the threaded nanofibers may have larger and smaller diameters and/or lengths if desired. In exemplary constructions, the structural carbon fibers 12, 14, making up the bed, may have extended lengths corresponding generally to the major lamina dimensions with diameters of about 0.5 to 100 micrometers and more preferably 1 to 10 micrometers. The structural carbon fibers may have larger and smaller diameters and/or lengths if desired.

In the exemplary 3D reinforcing fiber network, the structural carbon fibers 12, 14 are aligned in the x-y plane such as in the form of a mat or fabric and the z-threaded carbon nanofibers 10 are zig-zag threaded between the carbon fibers in the z-direction. In the exemplary composite, a polymer matrix 16 fills the interstitial spaces within the 3-D reinforcing fiber network to define the composite structure.

As will be readily appreciated, the carbon fiber bed may be packed relatively tightly so as to have a high carbon volume fraction such as 40%, 50% or higher. Accordingly, in real practice, the carbon nanofibers are typically arranged in a staggered pattern (instead of a straight in-line pattern) and cause the carbon nanofibers to zig-zag through the gaps between carbon fibers, although the long-range alignment of the carbon nanofibers is still in the z-direction (e.g., the average alignment angle of a carbon nanofiber in a domain more than the diameter of the micro-fiber of the FRP will be in the z-direction but the piecewise alignment angle of the carbon nanofiber could be following the tangential direction of the cross-section of micro-fiber inside the FRP). In this regard, it will be understood that the threading direction is defined by the major dimension traversed by the nanofibers and will not necessarily correspond with the travel direction of each individual segment as the nanofiber passes around the structural carbon fibers. The zig-zag threading pattern provides additional mechanical interlock between the nanofibers and the carbon fibers and helps to distribute loads as well as thermal and electrical energy more effectively among the matrix, the carbon nanofibers, and the carbon fibers.

Using carbon nanofibers as the z-threads in a CFRP has been found very effective and provides comprehensive improvement in many aspects. By way of example only, and not limitation, based on the published experimental data, improvements of carbon nanofiber ZT-CFRP over traditional CFRP (i.e., control CFRP) have been found in the mode-I delamination toughness (+29%), the through-thickness DC electrical conductivity (from +238% to +10000%), the through-thickness thermal conductivity (+652%), the Interlaminar Shear Strength (ILSS) (+17%), and the Longitudinal Compressive Strength (+14.83%). Furthermore, the carbon nanofibers z-threads helped to mitigate the impact of defects such as voids in the CFRP and provided more reliable material properties in all the tests. In comparison, in these publications, the CFRP with un-aligned carbon nanofibers were also tested and did not exhibit significant improvement.

The complex 3D reinforcing fiber network is also of interest. A finite element modeling effort shows that the carbon nanofiber z-threads can help to mitigate against the internal imbalanced transversal loads (due to voids or internal defects such as misalignment of carbon fibers) in both z-direction and the y-direction. The zig-zag nanofiber z-threads helped to distribute the stresses in a broader area and depth and thus can mitigate or delay the localized failure due to internal imbalanced transversal loads in the z-direction and y-direction, respectively.

According to one exemplary prior process for manufacturing ZT-CFRP prepreg materials following the principles described in U.S. Pat. No. 10,066,065 (which is hereby incorporated by reference in its entirety), a cold, solid phase z-aligned film containing nanofibers already aligned in the z-direction is placed on top of a heated fiber fabric incorporating structural carbon fibers oriented in an x-y plane as described in relation to FIG. 1 herein. The film base material is allowed to melt at the interface only with the remainder of the film remaining in a solid state, thereby maintaining the nanofiber alignment in the z-direction. The z-aligned film may be held within a porous carrier such as a sponge, nonwoven fabric or the like. By way of example only, the film base material may be thermoset resin (like B-staged epoxy), thermoplastic resin (like Nylon, polyester ether ketone (PEEK)), a mixture of both, and/or a phase-change material containing other additives or compounds, as long as the resin or other base material can be solidified at a cold temperature and melted at a hot temperature. During transfer, the film undergoes non-isothermal heating (i.e., the film is not heated uniformly causing a temperature gradient within the film) and localized phase change at the film/fabric interface. This process gradually feeds the z-aligned nanofibers into the fabric along the z-direction. The flow of the melted base material is maintained in the z-direction (i.e., “z-flow”) to guide the nanofibers threading through the fabric in the z-direction. The non-isothermal heating and z-directional flow guidance may be carried out using a vacuum bag driving force to pull the melted base material into the fiber fabric. In the final prepreg material, the film base transferred into the fiber fabric forms the matrix material 16 within the interstitial voids between the structural carbon fibers 12, 14 (FIG. 2).

While a batch transfer process may be highly useful, it has been found that to produce the ZT-CFRP prepreg material with desirable quality and in sufficient quantities for use in large-scale industries such as sporting goods, automotive, aerospace, wind energy, and the like, it may be desirable to develop a fully automated and continuous process for producing the ZT-CFRP prepreg.

### SUMMARY OF THE DISCLOSURE

The present disclosure offers advantages and alternatives by providing a continuous process to accomplish the same functionalities.

In accordance with one exemplary and non-limiting aspect, the present disclosure provides a process for continuous production of z-threaded fiber reinforced polymer composites. The process includes providing a pre-formed fiber fabric including a plurality of fibers oriented in at least one of crossing, parallel, or combined relation to one another within the fabric. The fiber fabric includes a fabric thickness dimension between a first fabric face and a second fabric face. The process also includes providing a pre-formed, solidified film having a film thickness dimension, wherein the film includes a heat-meltable base matrix material in combination with a plurality of z-aligned nanofibers disposed within the base matrix material and being oriented predominantly in the film thickness dimension. The solidified film is delivered into juxtaposed relation across one face of the fiber fabric. The film and fiber fabric are advanced in layered relation through a constricting matrix transfer station, wherein within the matrix transfer station the fiber fabric is heated to a temperature at or above the melting point of the base matrix material and the base matrix material progressively melts at an interface with the fabric face and flows with the nanofibers into the fiber fabric in the fabric thickness dimension as the film and fiber fabric are moving through the matrix transfer station. The matrix transfer station includes a constricting processing gap urging the film towards the fiber fabric through at least a portion of the matrix transfer station. The fiber fabric with entrained base matrix material and z-threaded nanofibers is removed from the matrix transfer station and the base matrix material is permitted to cool.

### BRIEF DESCRIPTION OF THE DRAWINGS

FIG. 1 is a schematic elevation perspective view of fibers in an exemplary carbon fiber reinforced polymer composite with z-threaded nanofibers formed by prior batch processing and which may be replicated by a substantially steady state process consistent with the present disclosure.

FIG. 2 is a schematic perspective cut-away view illustrating threaded nanofibers extending through a bed of structural fibers in an exemplary carbon fiber reinforced polymer composite with z-threaded nanofibers formed by prior batch processing and which may be replicated by a substantially steady state process consistent with the present disclosure.

FIG. 3 is a schematic view of an exemplary processing line for forming an exemplary carbon fiber reinforced polymer composite with z-threaded nanofibers by a substantially steady state process.

FIG. 4 is a schematic sectional view of an exemplary module for z-threading and polymer matrix transfer within the exemplary processing line of FIG. 3.

FIGS. 5A-D are schematic illustrations of various constricting channel arrangements for matrix transfer in a process consistent with the present disclosure.

FIG. 6 is another schematic illustration of a constricting channel arrangement for matrix transfer in a process consistent with the present disclosure.

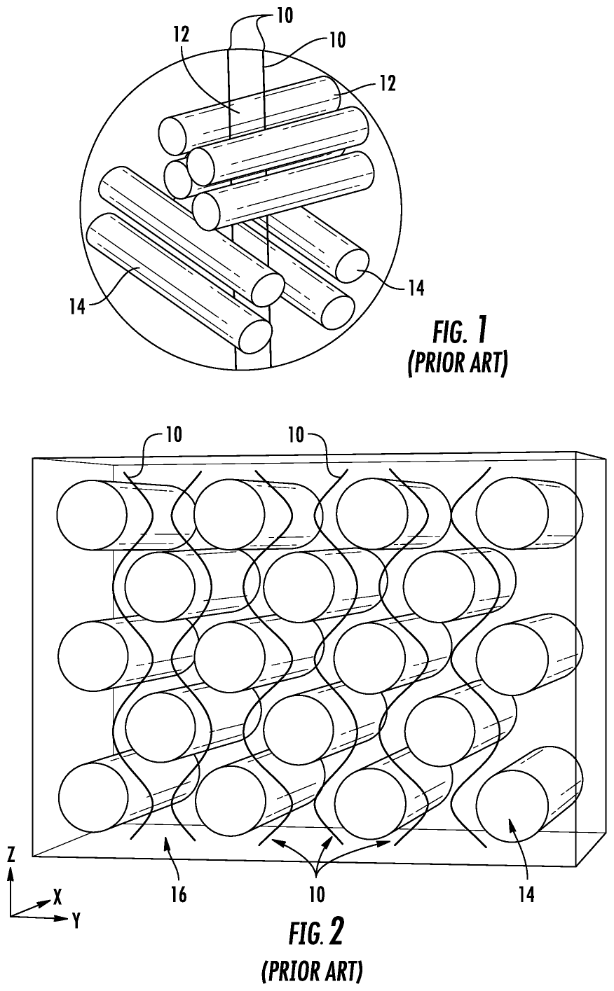

Before the exemplary embodiments are explained in detail, it is to be understood that the invention is in no way limited in its application or construction to the details and the arrangements of the components set forth in the following description or illustrated in the drawings. Rather, the invention is capable of other embodiments and of being practiced or being carried out in various ways. Also, it is to be understood that the phraseology and terminology used herein are for purposes of description only and should not be regarded as limiting. The use herein of terms such as “including” and “comprising”, and variations thereof is meant to encompass the items listed thereafter and equivalents thereof as well as additional items and equivalents thereof.

### DETAILED DESCRIPTION OF PREFERRED EMBODIMENTS

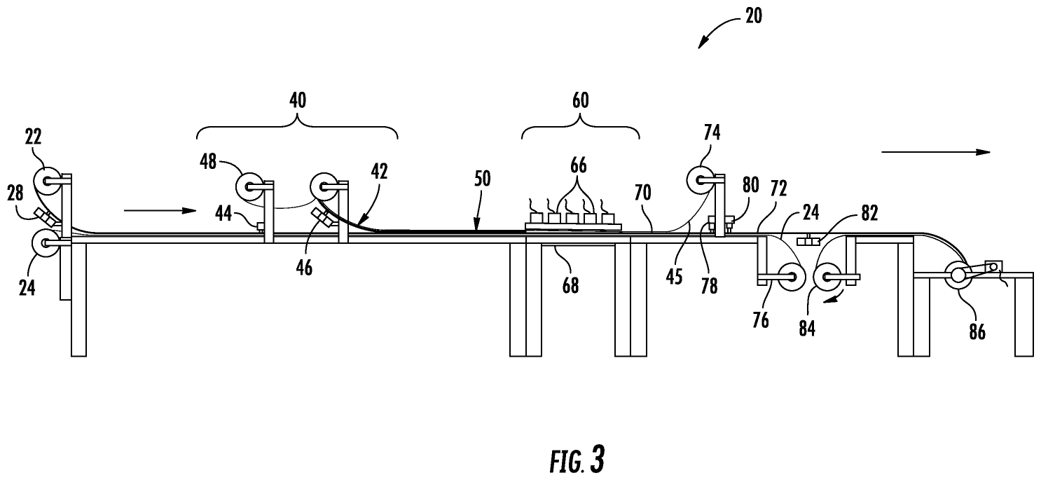

Reference will now be made to the drawings wherein like elements are designated by like reference numerals in the various views. FIG. 3 illustrates an exemplary processing line 20 for the substantially continuous automated production of a carbon fiber or other fiber reinforced polymer composite with z-threaded nanofibers. It will be understood that the term “continuous” refers to a process which can be stopped and started but which operates for some period of time with fresh raw materials being introduced manually or automatically at an upstream location position for delivery to one or more processing stations before the treatment of previously introduced raw materials is fully complete. In this regard, it will be understood that such a continuous process may be stopped and started as desired for maintenance, regeneration of raw materials, intentional downtime and the like as may be desired but will be contrasted to a so-called batch process in which raw materials are introduced and fully processed before new materials are introduced.

In the exemplary processing line 20 illustrated in FIG. 3, a roll of carbon fiber fabric 22 or other fiber fabric such as but not limited to KEVLAR, NOMEX, polyamide fabrics, ceramic fiber fabrics, metal fibers, glass fiber fabrics and the like with fibers oriented in an x-y plane is positioned at the processing line inlet. As will be readily understood, such fiber fabric will typically have opposing faces defining major dimensions of length and width separated by a more minor thickness dimension. A roll of backing material 24 such as paper, fabric, nonwoven matting, or the like may also be positioned at the processing line inlet. Both the fiber fabric 22 and the backing material 24 may be fed or pulled through the processing line 20 to corresponding collection rolls or other take-up devices such that the fiber fabric 22 and backing material 24 are pulled through the processing line 20 by tension during operation. A conveyor belt or the like may also be used to facilitate movement if desired. A sensor 28, such as an optical scanner, electrical conductivity sensor, or the like may be positioned at the inlet to monitor the condition, quality and/or alignment of the fiber fabric 22 entering the processing line. The rate that the fiber fabric 22 and backing material 24 enter the processing line 20 is preferably variable to be adjustable independently based on processing time requirements within the processing line 20 and the desired output rate of finished material.

In the illustrated exemplary process, the layered fiber fabric 22 and backing material 24 may be transferred from the inlet of the processing line 20 to a film placement zone 40. At film placement zone 40, a previously formed solid heat-meltable film 42 containing z-aligned carbon nanofibers is placed in juxtaposed relation to the fiber fabric such that the film is disposed across the face of the fiber fabric 22 facing away from the backing material. The film 42 is preferably in contact with the fiber fabric 22 but may be spaced slightly away if desired. As illustrated, one or more sensors 44 such as an optical sensor, conductivity sensor, metal detector, camera, or the like may be positioned at the entry to film placement zone 40 to monitor the integrity, quality and/or alignment and/or lack of contamination of the layered fiber fabric 22 and backing material 24. Chemical or other treatments may also be applied at this location. Likewise, one or more sensors 46 such as an optical sensor, metal detector, camera, or the like may be positioned to monitor the integrity and/or alignment and/or lack of contamination of film 42 prior to placement over fiber fabric 22. Chemical or other treatments may also be applied at this location.

In one exemplary practice, film 42 may include a polymer resin base matrix material in combination with z-aligned carbon nanofibers oriented predominantly in the thickness dimension. However, base materials other than polymer resins may likewise be used so long as such materials may be melted at high temperatures and solidified at cooler temperatures. By way of example only, meltable thermoset resin such as B-staged epoxy or the like, meltable thermoplastic resin such as Nylon, polyester ether ketone (PEEK), polymer derived ceramic, a phase-change material and/or mixtures of any of the foregoing may be used. As will be appreciated, the melting point for any polymer or non-polymer base material can be extremely high if desired since the z-aligned carbon nanofibers can withstand temperatures over 3000 degree C. in an oxygen deficient environment such as an encapsulating film. Low melting point materials may also be used.

It is to be understood that the film is subject to a wide variety of thicknesses as may be desirable for the intended level of impregnation (i.e., matrix material content in the prepreg material being produced). Film thicknesses ranging from 0.01 mm up to 20 mm or greater may be particularly useful. Importantly, it is to be understood that while film 42 may be formed using practices as described in U.S. Pat. No. 10,066,065, film 42 may likewise be formed by any other suitable technique as may be desired. It will be understood that film 42 may be housed within a porous carrier material such as a sponge, nonwoven textile, or the like. Alternatively, film 42 may be an independently supported film without a supporting carrier material.

The nanofibers within film 42 may be carbon or other suitable material such as glass, structural polymers, or the like. According to a potentially preferred practice, the nanofibers within film 42 may have average diameters of 0.001 to 1 micrometer and more preferably 0.01 to 0.15 micrometers with lengths of 10 to 1500 micrometers and more preferably 100 to 500 micrometers. In this regard, it will be understood that the nanofibers within film 42 need not be straight relative to the thickness dimension of film 42. However, at least a majority of the nanofibers having lengths in the range of 100 to 500 micrometers will preferably be aligned generally in the thickness dimension of film 42 such that the ends of those fibers have a difference in elevation measured in the thickness dimension of film 42 which is between 51% and 100% of the fiber length. More preferably, 60% to 100% of the nanofibers in film 42 having lengths in the range of 100 to 500 micrometers will satisfy such alignment features. Accordingly, by way of example only, a carbon nanofiber having a length of 100 micrometers will preferably have an elevation distance between ends of at least 51 micrometers when measured in the thickness dimension of the film 42.

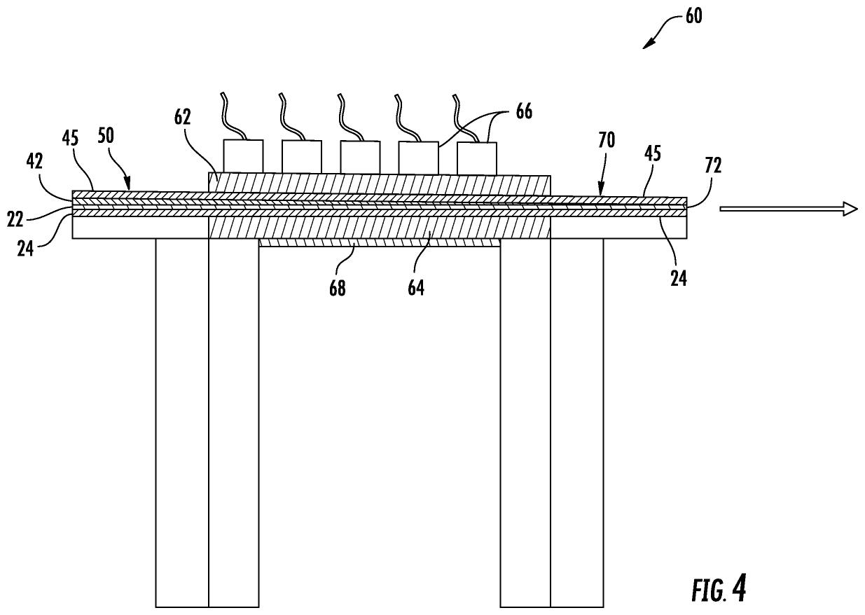

Because film 42 may tend to be tacky, it may be desirable to use paper or other barrier materials to cover the surfaces of film 42 during storage. As illustrated, a collection roll 48 or other suitable take-up device may be used to peel paper or other barrier materials away from the surface of film 42 to be placed in contact with fiber fabric 22. Any paper or other barrier material across the surface of the film 42 facing away from fiber fabric 22 may remain in place during subsequent processing wherein the base matrix and aligned nanofibers of film 42 are transferred into the fiber fabric 22 in accordance with potentially preferred practices as will now be described. In addition, or as an alternative to using paper or other barrier materials to cover the tacky film 42, the surfaces of the top plate 62 and the bottom plate 64 (see FIG. 4) could be coated in a suitable material.

Referring now jointly to FIGS. 3 and 4, in the illustrated exemplary process, a multi-layered preliminary stacked material 50 of backing material 24, fiber fabric 22, film 42 with z-aligned nanofibers, and paper or other cover material 45 is transported from film placement station 40 to a matrix transfer station 60 wherein the base matrix material from film 42 is progressively transferred into fiber fabric 22 along with the z-aligned nanofibers to form a z-threaded fiber reinforced polymer composite.

In one exemplary construction, matrix transfer station 60 may include a top plate 62 and a bottom plate 64 of ferrous or nonferrous metal or other structural material with spacing between top plate 62 and bottom plate 64 defining a channel for passage of stacked material 50 during processing. The materials forming top plate 62 and bottom plate 64 will preferably have good thermal conductivity to facilitate the use of external heating and cooling elements to provide localized temperature control to the stacked material during processing. By way of example only, stainless steel or other high alloy metals with substantial corrosion resistance may be particularly desirable.

As illustrated, one or more cooling elements 66 are preferably disposed across top plate 62 and one or more heating elements 68 are disposed across bottom plate 64. While cooling elements 66 and heating elements 68 are illustrated as contact-type elements, it is contemplated that non-contact cooling elements and heating elements may likewise be used if desired. By way of example only, in accordance with one exemplary practice, cooling elements 66 may be set to maintain top plate 62 at a temperature of about 10 degrees Celsius to about 40 degrees Celsius, and most preferably about 23 degrees Celsius. Heating elements 68 for example but not limited to, are preferably set to maintain bottom plate 64 at a temperature of about 80 degrees Celsius to about 120 degrees Celsius for an epoxy resin film. Other temperatures may be used for other matrix materials to facilitate localized melting at the fiber fabric interface. This temperature is set to raise the temperature of the fiber fabric at or above the melting point of the film. The temperature is no less than the melting temperature of the film but is also not so hot as to cause immediate melting of base matrix and/or burn the polymer or other matrix material. The temperature may be tuned during operation based on observation of whether or not transfer is completed within the length of the matrix transfer station. In this regard, complete melting and transfer of the film matrix base may be desired. The temperature differential between the top plate temperature and the bottom plate temperature assists in promoting localized melting and matrix transfer at the interface between film 42 and fiber fabric 22 without melting the matrix material at locations above the interface prematurely.

As shown, the spacing between top plate 62 and bottom plate 64 may progressively narrow through the matrix transfer station 60. That is, the width between top plate 62 and bottom plate 64 is greater at the entrance to matrix transfer station 60 than at the exit. In this regard, the ratio of inlet spacing to outlet spacing between top plate 62 and bottom plate 64 is preferably in the range of 1.1:1 to 25:1 and more preferably in the range of 1.15:1 to 12:1. By way of example only, the constriction from the entrance to the exit of matrix transfer station 60 may be achieved by angling the top plate down at an angle in the range of 0.1 degrees to 15 degrees from horizontal in conjunction with angling the top plate up at an angle in the range of 0.1 degrees to 15 degrees from horizontal. Larger and smaller angles may likewise be used as desired. The angles of top plate 62 and bottom plate 64 may be of the same magnitude or different magnitudes. Moreover, only one of the plates may be angled if desired.

As best seen in FIG. 4, in the exemplary process, matrix transfer station 60 produces a stacked structure 70 having a z-threaded fiber reinforced composite 72 disposed between backing material 24 and cover material 45. As best seen in FIG. 3, cover material 45 (if present) may be subsequently removed by a cover collection roll 74 or other suitable take-up device and backing material 24 (if present) may be subsequently removed by a backing collection roll 76 or another suitable take-up device. Sensors 78, 80, 82 such as optical sensors, conductivity sensors, metal detectors, cameras, or the like, including combinations of any of the foregoing may be arranged along processing line 20 to monitor z-threaded composite 72 as any cover and backing material are removed. After transferring the z-aligned resin matrix, within the matrix transfer station, the heated z-threaded composite 72 containing melted resin and z-aligned nanofibers may be cooled quickly to the temperature at which the melted resin or other matrix material becomes solid again. If desired, a cooling module (not shown) may be used to blow cool air on the hot layered stack leaving the outlet.

In accordance with the illustrated exemplary practice, a protective film 84 or the like may be introduced across the underside of z-threaded composite 72 prior to final collection at exit roll 86 or another suitable take-up device. As will be understood, in this arrangement, protective film 84 will act as a barrier between layers of z-threaded composite 72 within the final roll thereby blocking any undesired adhesion and facilitating ease of unrolling during subsequent use. While not shown in the FIG. 3, the protective film 84 may be applied on both sides of the z-threaded composite 72 to protect both sides of the z-threaded composite 72 and facilitate further easier handling of the z-threaded composite 72.

It is contemplated that the exemplary process as illustrated and described in relation to the exemplary FIGS. 3 and 4 may be susceptible to a number of useful variations. By way of example, it is to be understood that while the illustrated version of machine design orients the hot side on the bottom and the cold side on the top, these relative positions may be reversed if desired such that the hot side on the top and the cold side is on the bottom. In this regard, the top and bottom side features may be readily adjusted as desired along with the corresponding order of the fiber fabric and the film in an altered design.

It is also contemplated that vacuum assistance may be applied to help guide the flow and remove any volatile, vapor, or gas. The vacuum can be drawn through the fiber fabric 22 since it is porous before being completely saturated with matrix material from film 42. Moreover, it is to be understood that nanofiber z-threading and matrix film transfer consistent with the present disclosure may be carried out using materials other than carbon fiber fabric including (but not limited to) glass fiber fabric, ceramic fiber fabric, metal fabric, polymer fiber fabrics including nylon, polyester, Kevlar, Nomex, etc. and to all kinds of nanofibers and long nanoparticles including (but not limited to) carbon nanofibers, carbon nanotubes, any particles with significant length to width or diameter ratio which are small enough to thread through the receiving fabric structure.

In accordance with one exemplary practice, the nature and/or configuration of the metal plates or other shaping surfaces for the z-threaded composite may be varied. The opposing shaping-surfaces can be either curved or straight and can be either stationary or moving. By way of example only, and not limitation, several exemplary shaping surface configurations are illustrated in FIG. 5. As shown in FIG. 5A, either the top or the bottom plate may be sloped, while the opposing plate remains level. As shown in FIG. 5B, the top and/or the bottom plate may define a curved surface. As shown in FIG. 5C, the top and/or the bottom plate may have an irregular texturing pattern. As shown in FIG. 5D, at least one of the opposing texturing surfaces may be movable such as a roll or the like. As will be noted, in each of these configurations, the spacing between opposing surfaces may gradually narrow over the transfer zone. As will be appreciated, the lengths and shapes of the shaping-surfaces, the shaping gap decreasing rate (along the pulling direction), the heat transfer, the pressure, and the speed of resin flowing into the fabric may all be optimized to achieve desired non-isothermal heating phase-change and “z-directional flow” of the resin matrix and aligned nanofibers.

The opposing shaping-surfaces, which can be either curved or straight, may have a gap distance which is overall decreasing along the fabric's pulling direction such that the average slope is negative, but still includes a degree of local waviness or roughness within the gap. Such local waviness or roughness can be due to machining inaccuracy or can be created intentionally for functional reasons such as reducing friction by allowing air flow to enter the cavity, creating small fluctuation or vibration on the film or the fabric to promote the resin impregnation and the nanofiber z-threading process, or creating partially non-z-threading nanofibers on the surface of the fabric. The local waviness or roughness can be on either the fabric side shaping surface or the film side shaping surface or both.

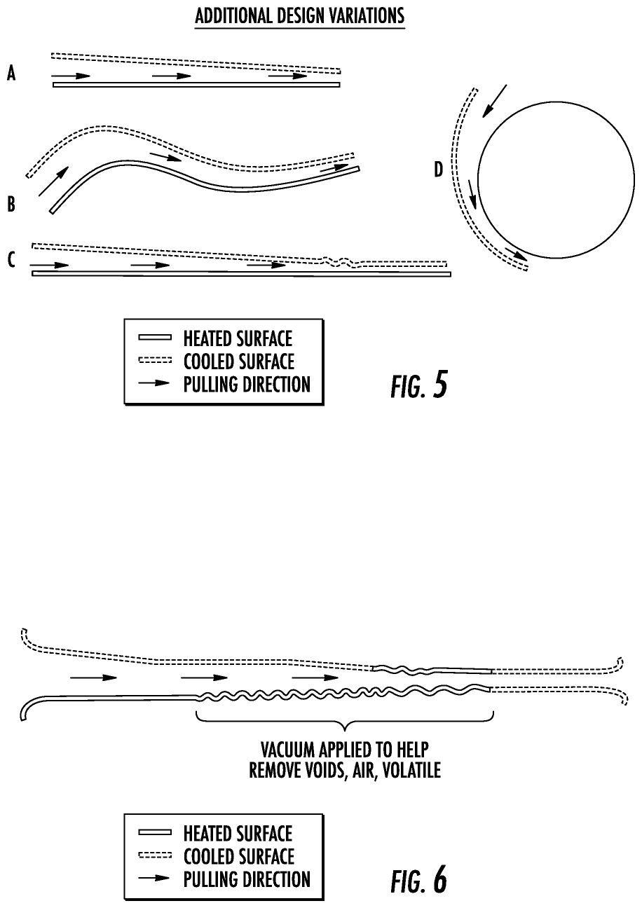

By way of example only, a surface-modified z-threaded fiber reinforced polymer prepreg may be produced with nanofiber z-threads inside the prepreg and some additional nanofibers not z-aligned on the surface of the ZT-FRP prepreg by using two shaping-surfaces which can be either curved or straight, with two sections. In such an embodiment, a first section of the gap may be monotonically decreasing along the fabric's pulling direction and a subsequent second section may be overall monotonically decreasing along the fabric's pulling direction but with some degree of local waviness or roughness. By way of example only, and not limitation, one such exemplary arrangement is illustrated in FIG. 6. Accordingly, when the layered stack passes through the second section, a portion of the nanofibers are disturbed and not threaded through the fabric in the z-direction. The nano fibers that are not z-threaded thereby form a reinforcement on the surface of the fabric in the x-y plane with the nanofiber z-threads and the non-z-aligned nanofibers further forming a reinforcing network on the surface of the fabric and the z-threaded prepreg.

As also illustrated in FIG. 6, the opposing two shaping-surfaces, which can be either curved or straight, can be divided into several sections wherein at least one section forms a channel having the gap (distance) monotonically decreasing along the fabric's pulling direction. Other sections can have different temperature control plans and waviness or gap increasing/decreasing rates that can be any values and need not be monotonically decreasing along the fabric's pulling direction.

In practice, a multi-sectional design may be useful for a number of purposes. By way of example only, a multi-sectional design may be used to massage dry fabric and open gaps among fibers for easier resin transfer and z-threading and/or to massage the prepreg to help nanofibers and carbon fibers settlement to the tightest or other stable relative position. In any embodiment, vacuum may be applied in the channel between the two shaping surfaces to help remove voids, air, and/or volatiles.

Various treatment stations can also be included within processing line 20 if desired. By way of example only, and not limitation, treatments may include adding surfactants, lubricants, PH level adjustment agents, release agents (e.g., wax), particles (e.g., nanoparticles, micro-particles, rubber particles, thermal plastics particles, carbon blacks, etc.), coating, or slurry to form interleaves on the surface of the z-threaded prepreg. Additional layers of coating (i.e., interleave) of nanofibers/resin mixture may be sprayed or applied by roller or brush, etc. to enhance the in-plane (i.e., x-y plane) shear strength of the CFRP laminate as the x-y plane orientated nanofibers can help distribute the shear stresses in the x-y plane. Thus, addition of some such non-z-aligned nanofiber/resin coating (or interleave) to the surface of z-threaded prepreg may be beneficial in some circumstances. Regarding treatment, the fiber fabric 22 and/or film 42 can be treated as they are introduced into processing line before matrix transfer station 60. The z-threaded composite 72 may be treated at any time during or after formation. Such treatments may be applied either directly to the z-threaded composite or may be applied by previously treated backing material 24 and/or cover material 45.

Inspection modules or treatment modules can also be added to the modified hot-melt process-based ZT-FRP prepreg production machine. Referring to FIG. 3, by way of example only, in accordance with one exemplary practice, one can inspect the alignment, and/or uniformity and/or quality of the fiber fabric generally at the position shown for sensor 28 and/or sensor 44; and/or one can inspect the alignment and quality of the film containing z-aligned nanofibers generally at the position shown for sensor 46 and/or one can inspect the ZT-CFRP prepreg quality generally at the positions shown for any of sensors 78, 80, 82. Note that the inspection techniques for fabric, film, and ZT-FRP prepreg can be based on microscopy, thermal conductivity, electrical conductivity, dielectric constant, ultrasound response, hardness, etc. Regarding the treatment modules, one can treat the fiber fabric generally at the positions shown for sensor 28 and/or sensor 44 (with sensors either present or not) and/or one can treat the film containing z-aligned nanofibers generally at the position shown for sensor 46 (with a sensor either present or not); one can likewise treat the backing papers generally at the positions shown for sensors 28 and/or sensor 44 (with sensors either present or not) and/or one can treat the ZT-CFRP prepreg generally at the positions shown for any of sensors 78, 80, 82 (with sensors either present or not). Of course, it is to be understood, that the forgoing description is exemplary only and is in no way limiting and that inspection and/or treatment locations may be added or eliminated as desired to carry out the described activities as well as other activities as may be desired.

It is to be understood that preferred embodiments of this disclosure are described herein, including the best mode known to the inventors for carrying out the disclosure. However, variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Various features of the disclosure are set forth in the following claims.

What is claimed is:

1. A process for continuous production of z-threaded fiber reinforced polymer composites, comprising the steps of:
(a) providing a pre-formed fiber fabric comprising a plurality of fibers oriented in at least one of crossing, parallel, or combined relation to one another within the fabric, the fiber fabric comprising a fabric thickness dimension between the first fabric face and the second fabric face;
(b) providing a pre-formed, solidified film having a film thickness dimension, the film comprising a heat-meltable base matrix material in combination with a plurality of z-aligned nanofibers disposed within the base matrix material and being oriented predominantly in the film thickness dimension;
(c) delivering the solidified film into juxtaposed relation across one face of the fiber fabric;
(d) advancing the film and fiber fabric in layered relation through a constricting matrix transfer station, wherein within the matrix transfer station the fiber fabric is heated to a temperature at or above the melting point of the base matrix material and the base matrix material progressively melts at an interface with the fabric face and flows with the nanofibers into the fiber fabric in the fabric thickness dimension as the film and fiber fabric are moving through the matrix transfer station, the matrix transfer station comprising a constricting processing gap urging the film towards the fiber fabric through at least a portion of the matrix transfer station; and
(e). removing the fiber fabric with entrained base matrix material and z-threaded nanofibers from the matrix transfer station and permitting the base matrix material to cool.

2. The process as recited in claim 1, wherein the fiber fabric is a woven or nonwoven carbon fiber fabric.

3. The process as recited in claim 1, wherein chemical surface treatments are applied to at least one of the pre-formed fiber fabric and pre-formed, solidified resin film upstream from the matrix transfer station.

4. The process as recited in claim 1, wherein at least one of the pre-formed fiber fabric and pre-formed, solidified film is monitored by a sensor upstream from the matrix transfer station.

5. The process as recited in claim 1, wherein the film thickness is in the range of 0.01 mm up to 20 mm.

6. The process as recited in claim 1, wherein the pre-formed, solidified film is selected from the group consisting of a meltable thermoset resin, a meltable thermoplastic resin, a polymer derived ceramic, a phase-change material, and mixtures of any of the foregoing.

7. The process as recited in claim 1, wherein the nanofibers within the film are characterized by average diameters of 0.001 to 1 micrometer

8. The process as recited in claim 1, wherein the nanofibers within the film are characterized by lengths of 10 to 1500 micrometers.

9. The process as recited in claim 1, wherein at least a majority of the nanofibers within the pre-formed, solidified film having lengths in the range of 100 to 500 micrometers are aligned in the thickness dimension of pre-formed, solidified film such that the ends of those fibers have a difference in elevation measured in the thickness dimension of the pre-formed, solidified film which is between 55% and 100% of the fiber length.

10. The process as recited in claim 1, wherein the matrix transfer station comprises a top plate and a bottom plate with spacing between the top plate and bottom plate defining a channel for passage of the film and fiber fabric in stacked relation during processing.

11. The process as recited in claim 10, wherein one or more cooling elements are disposed in operative relation to the top plate to maintain the top plate at a temperature below the melting point of the base matrix material and one or more heating elements are disposed in operative relation to the bottom plate to maintain the bottom plate at a temperature at or above the melting point of the base matrix material.

12. The process as recited in claim 10, wherein the ratio of inlet spacing to outlet spacing between the top plate and the bottom plate is in the range of 1.1:1 to 12:1.

14. The process as recited in claim 10, wherein a vacuum force is applied across the face of the fiber fabric facing away from the film within the matrix transfer station.

15. A process for continuous, automated production of z-threaded fiber reinforced polymer composites, comprising the steps of:
(a) providing a pre-formed carbon fiber fabric comprising a plurality of carbon fibers oriented in at least one of crossing, parallel, or combined relation within the fabric, the carbon fiber fabric comprising a fabric thickness dimension between the first fabric face and the second fabric face;
(b) providing a pre-formed, solidified resin film having a film thickness dimension, the resin film comprising a meltable polymer in combination with a plurality of z-aligned carbon nanofibers having average diameters of 0.01 to 1 micrometer disposed within the polymer and being oriented predominantly in the film thickness dimension;
(c) delivering the resin film into contacting, juxtaposed relation across one face of the carbon fiber fabric; and
(d) advancing the resin film and carbon fiber fabric in contacting layered relation through a constricting matrix transfer station in conjunction with a covering material and a backing material, wherein within the matrix transfer station the carbon fiber fabric is heated to a temperature at or above the melting point of the meltable polymer and the meltable polymer progressively melts at an interface with the fabric face and moves with the nanofibers into the carbon fiber fabric in the fabric thickness dimension, the matrix transfer station comprising a constricting processing gap urging the resin film towards the carbon fiber fabric through at least a portion of the matrix transfer station;
(e). removing the carbon fiber fabric with entrained meltable polymer and z-threaded nanofibers from the matrix transfer station and permitting the meltable polymer to cool.
